(19) United States
(12) Patent Application Publication
(10) Pub. No.: US 2013/0194432 A1
(43) Pub. Date: Aug. 1, 2013

(54) IMAGING APPARATUS AND METHOD OF IMPROVING IMAGE QUALITY OF IMAGED IMAGE

(71) Applicant: Fujitsu Limited, Kawasaki-shi (JP)

(72) Inventors: Nobuyuki Kanto, Kobe (JP); Masayoshi Shimizu, Hadano (JP); Hiroyasu Yoshikawa, Akashi (JP); Yukio Hirai, Akashi (JP); Takuya Kamimura, Kobe (JP)

(73) Assignee: FUJITSU LIMITED, Kawasaki-shi (JP)

(21) Appl. No.: 13/721,493

(22) Filed: Dec. 20, 2012

(30) Foreign Application Priority Data
Jan. 23, 2012 (JP) 2012-011386

(51) Int. Cl. H04N 5/33

(52) U.S. Cl. CPC H04N 5/332
USPC 348/164

(57) ABSTRACT

An apparatus includes: an infrared light source configured to emit an infrared light within a specific wavelength band; an imaging element configured to output a color signal which corresponds to an incident light; an optical filter configured to be always inserted into an optical path to the imaging element and attenuate an infrared light with a wavelength outside the specific wavelength band; and a color corrector configured to correct the color signal output from the imaging element and approximate spectral sensitivity characteristics of each color of the imaging element in the specific wavelength band of a wavelength band of an infrared light to human cone characteristics.

### CROSS-REFERENCE TO RELATED APPLICATION

This application is based upon and claims the benefit of priority of the prior Japanese Patent Application No. 2012-011386, filed on Jan. 23, 2012, the entire contents of which are incorporated herein by reference.

### FIELD

The embodiments discussed herein are related to imaging techniques of color images.

### BACKGROUND

Some imaging apparatuses which image color images are provided with infrared cut filters which transmit visible light but block infrared light in order to improve color reproducibility, by approximating spectral sensitivity characteristics of an imaging element in an infrared region to human cone sensitivity characteristics.

In addition, many infrared radiation type imaging apparatuses which include monitoring cameras, and the like, are provided with infrared cut filters. In such monitoring cameras, imaging is generally carried out by using the infrared cut filters in the daytime, and by removing the infrared cut filters at night for imaging with high sensitivity. A mechanism for inserting and extracting the infrared cut filter into and from an imaging optical path, provided for carrying out such imaging, becomes an obstacle for reducing sizes and costs of imaging apparatuses.

Further, such a visual line detection apparatus is known, which images, by an imaging apparatus, infrared images of eyes irradiated by light emitting infrared light using a near-infrared light emitting diode, and the like, and which detects a visual line of a person by using this imaged image. In order to provide personal computers, mobile communications devices, and the like, with both a photographing function for such uses and the photographing function for normal visible images, it is desired not to use the infrared cut filter in the imaging apparatus equipped to these devices from the viewpoint of reduced sizes and reduced costs of the apparatus.

As techniques for responding to such a request, some techniques are known which perform image processing of correcting colors to the image imaged by the imaging apparatus with the infrared cut filter removed. As one of such techniques, such a technique is known which performs a matrix operation of color signals of each color output from the imaging element and predetermined correction coefficients, and performs the above mentioned color correction.

Techniques described in each of the following documents are known.
Document 1: Japanese Patent No. 4407448
Document 2: Japanese Laid-open Patent Publication No. 2008-289001
Document 3: Japanese Laid-open Patent Publication No. 2004-32243
Document 4: Japanese Laid-open Patent Publication No. 2011-101006
Document 5: Yoshitaka Toyoda, et al., “Near Infrared Cameras to Capture Full Color Images-A Study of Color Reproduction Methods Without an Infrared Cut Filter for Digital Color Cameras-”, ITE Journal, The Institute of Image Information and Television Engineers, January 2010, Vol. 64, No. 1, pp. 101 to 110

In images obtained from the imaging by the imaging apparatus with the infrared cut filter removed, the higher a reflection rate in an infrared region of a color of an imaging object relative to the reflection rate in a visible region is, the more different from the original color the color of the imaging object is.

Explanation is given for FIGS. 1 and 2, respectively.

FIG. 1 is a graph which illustrates spectral sensitivity characteristics of an imaging element. In this graph, each graph of “an R component”, “a G component”, and “a B component” illustrates the spectral sensitivity characteristics for each color of the three primary colors; red, green, and blue.

FIG. 2 is a graph which illustrates spectral reflectivity characteristics of a color sample. This color sample is the color sample composed of 24 colors in Macbeth ColorChecker (registered trademark).

In this imaging element, in a state of the infrared cut filter being removed, the higher the reflection rate in the infrared region of the color sample relative to the reflection rate in the visible region is, the more spectrum in the infrared region is detected. In this case, since the difference in brightness for each of the R component, the G component, and the B component gets small, the obtained image has lighter color compared with the image obtained from the imaging which uses the infrared cut filter, and gets closer to an achromatic image.

Explanation is given for FIG. 3. FIG. 3 is an example of an imaged image of Macbeth ColorChecker. Here, the image of [A] is imaged by using the infrared cut filter, while the image of [B] is imaged without using the infrared cut filter. Both images are imaged under illumination of an incandescent bulb which contains large amount of infrared light.

In reference to the image of FIG. 3, it is seen that color density differs in accordance with the sample colors. This occurs due to the fact that the spectral reflectivity characteristics differ for each color sample, as illustrated in the graph of FIG. 2. In FIG. 3, as a tendency of the entire image, the image of [B] has a lighter color than the image of [A], although it is a little hard to distinguish the difference since FIG. 3 is not a colored image.

As mentioned above, in the imaging by the imaging element with the infrared cut filter removed, compared with when the infrared cut filter is used, significant color deterioration is observed in the imaged image.

The color deterioration in the imaged image is improved by employing the technique of color correction by a matrix operation of color signals of each color output from the imaging element and predetermined correction coefficients. When the color correction by this technique was attempted, however, it was found that a large amount of noise is included in the image after correction. Accordingly, in order to obtain images with high image quality, it is desired to suppress such noise.

### SUMMARY

According to an aspect of the embodiment, an apparatus includes:

an infrared light source configured to emit an infrared light within a specific wavelength band;

an imaging element configured to output a color signal which corresponds to an incident light;

an optical filter configured to be always inserted into an optical path to the imaging element and attenuate an infrared light with a wavelength outside the specific wavelength band; and

a color corrector configured to correct the color signal output from the imaging element and approximate spectral sensitivity characteristics of each color of the imaging element in the specific wavelength band of a wavelength band of an infrared light to human cone characteristics.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a graph which illustrates spectral sensitivity characteristics of an imaging element.

FIG. 2 is a graph which illustrates spectroscopic characteristics of color samples.

FIG. 3 illustrates examples of imaged images of Macbeth ColorChecker.

FIG. 4 is a configuration diagram of an embodiment of an imaging apparatus.

FIG. 5 illustrates an example of wavelength characteristics of a near infrared light emitting diode which may be used for the imaging apparatus of FIG. 4.

FIG. 6 illustrates an example of characteristics of an optical filter 13 which may be used for the imaging apparatus of FIG. 4.

FIG. 7 is a hardware configuration diagram of an image processor.

FIG. 8 is a flowchart which graphically illustrates a processing content of image processing.

FIGS. 9A and 9B illustrate an example of the image when color correction by a matrix operation is performed to color signals without using an infrared cut filter, and an example of the image when color correction by the matrix operation is performed to color signals using the optical filter of examples.

FIGS. 10A, 10B and 10C illustrate a simulation result of the image obtained when the optical filter used for the imaging apparatus described in Document 1 is used.

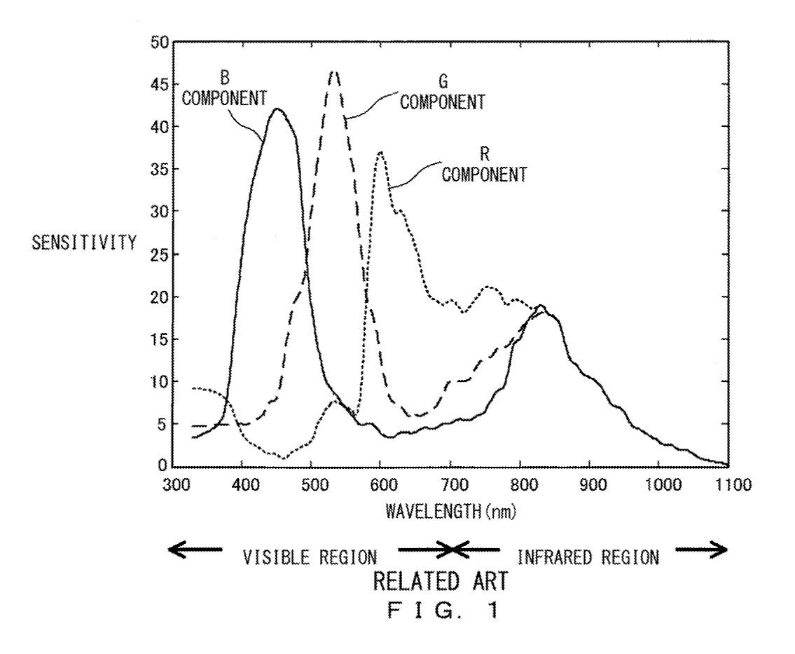

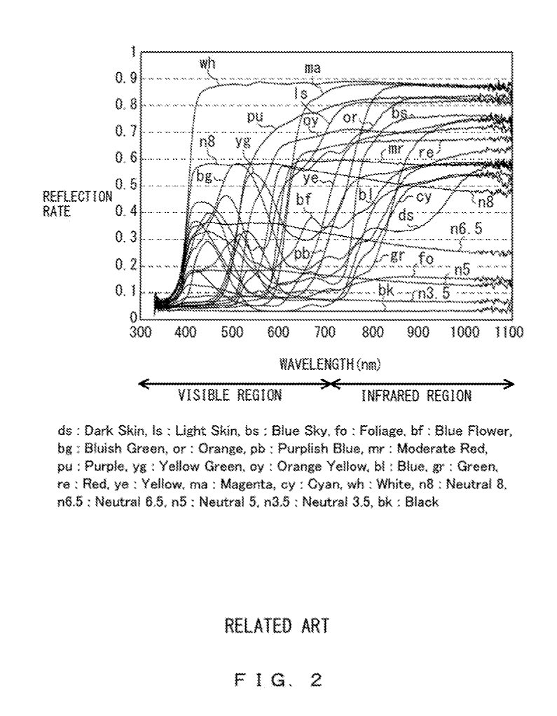

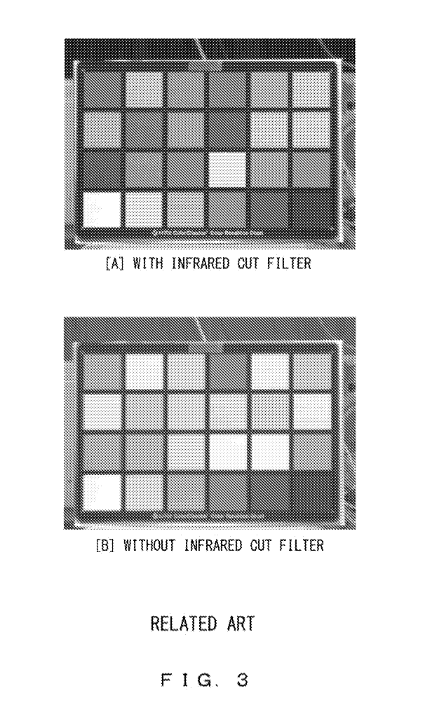

### DESCRIPTION OF EMBODIMENTS

Preferred embodiments of the present invention will be explained with reference to accompanying drawings.

Inventors of the present application researched in detail on a generation mechanism of the above mentioned noise which occurs when photographing the normal visible image by the imaging element which has sensitivity to the near infrared by removing the infrared cut filter. With this research, it was confirmed that this noise is caused by the size of the value of a matrix coefficient in a matrix operation for the above mentioned color correction, and that as the value of a matrix coefficient becomes larger, the amount of noise increases accordingly. Consequently, it was found out that, in order to suppress the noise, the value of a matrix coefficient may be made smaller by reducing the amount of the infrared light received and the correction amount of the color correction.

Further, as mentioned above, when personal computers or mobile communication devices, and the like, are provided with both a photographing function of an infrared image and a photographing function of a normal visible image, a specific wavelength is used as an infrared light source used for photographing the infrared image. On the other hand, the infrared light included in an incandescent bulb or sunlight used as an illumination in photographing the normal visual image, causes to induce the noise in the above mentioned color correction. This infrared light, however, is a continuous spectrum.

Then, one embodiment of the imaging apparatus for which the explanation is given hereafter uses an optical filter which transmits the wavelength of the infrared light used for photographing the infrared image but blocks the infrared light with the wavelength outside the wavelength of the infrared light used for photographing the infrared image and suppresses generation of noise in color correction.

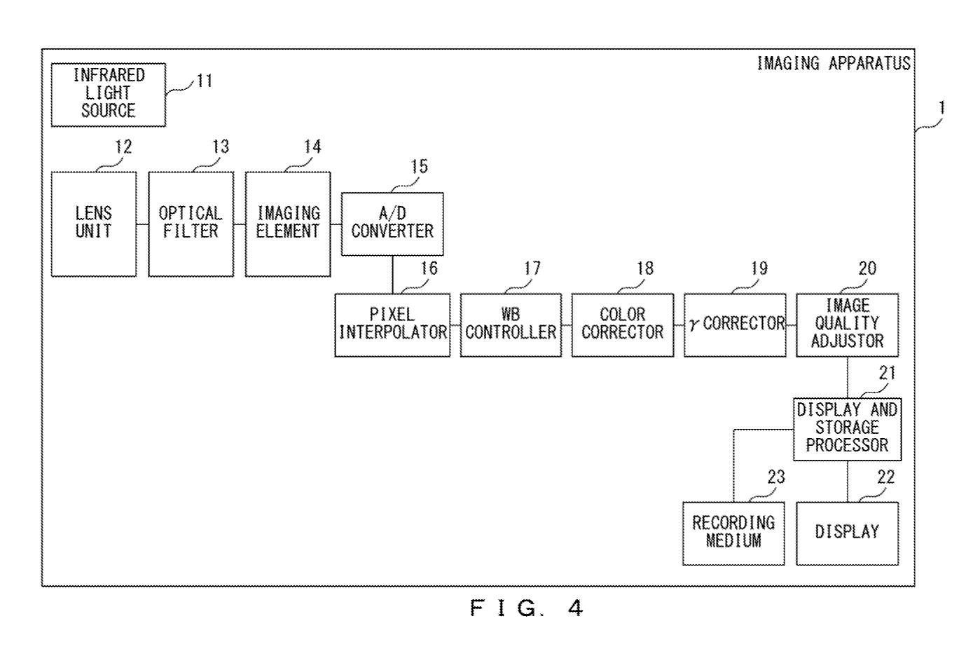

Explanation is given for FIG. 4. FIG. 4 is a configuration diagram of an embodiment of the imaging apparatus.

The imaging apparatus 1 includes an infrared light source 11, a lens unit 12, an optical filter 13, an imaging element 14, an A/D converter 15, a pixel interpolator16, a White Balance (WB) controller 17, a color corrector 18, a γ corrector 19, an image quality adjustor 20, a display and storage processor 21, a display 22, and a recording medium 23.

The infrared light source 11 is a light source which emits the infrared light within a specific wavelength band, and for example, the near infrared light emitting diode is used as the infrared light source 11. In the present embodiment, the near infrared light emitting diode which emits the near infrared light with a wavelength in a range of nearly 800 nm to 900 nm is used, many of which are used as the infrared radiation type active sensors including monitoring cameras, and the like. The infrared light source 11 is lighted when imaging the infrared image of human eyes used for the above mentioned visual line detection functions, while the infrared light source 11 is unlighted when imaging the normal visible images.

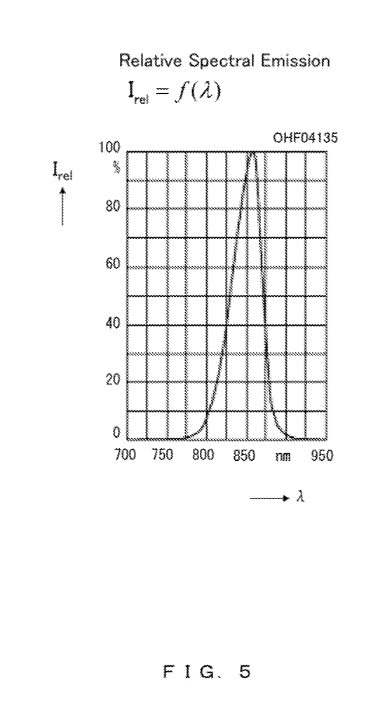

FIG. 5 illustrates an example of wavelength characteristics of the near infrared light emitting diode which may be used for the imaging apparatus 1. In the near infrared light emitting diode, the wavelength of the light emitting near infrared light has characteristics of nearly 850±25 nm (half width).

The lens unit 12 is a unit in which a plurality of optical components such as lenses, and the like, are combined, and the lens unit 12 forms the image of a subject on a light receiving surface of the imaging element 14 by condensing light from the subject.

The optical filter 13 attenuates the infrared light with the wavelength outside the above mentioned specific wavelength band in the infrared lights.

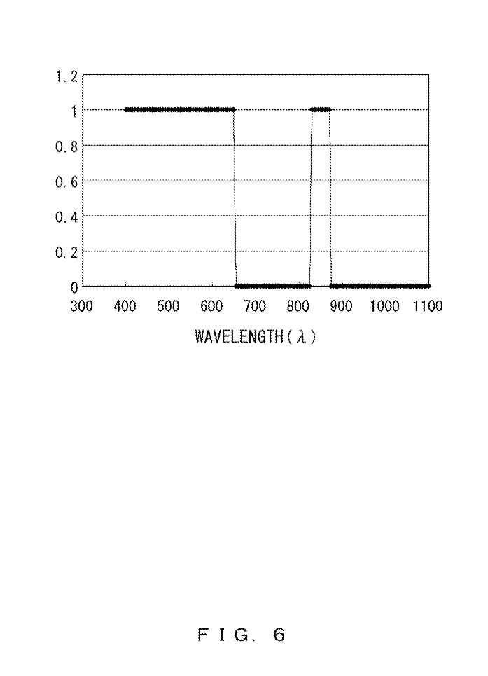

FIG. 6 illustrates an example of characteristics of the optical filter 13 which may be used for the imaging apparatus 1. The characteristics are adjusted for the case in which the near infrared light emitting diode having the wavelength characteristics of FIG. 5 is used as the infrared light source 11, and the characteristics attenuate the infrared light outside the wavelength band of nearly 850±25 nm and transmit the infrared light within the wavelength band.

When the above mentioned near infrared light emitting diode which emits the near infrared light with a wavelength of nearly 800 nm to 900 nm is used as the infrared light source 11, the optical filter 13 which has the characteristics of attenuating the infrared light outside the wavelength band of 800 nm to 900 nm is used.

As explained, for example, in the above described Document 1, it is said that human color vision has almost no sensitivity characteristics to a region having a wavelength longer than approximately 700 nm even if such a region is a visible light region. Accordingly, by setting a lower limit of an optical wavelength attenuated by the optical filter 13 as 700 nm, the optical filter 13 may be provided with characteristics which transmit the light with the wavelength shorter than the lower limit and the infrared light with the wavelength within the above mentioned specific wavelength band.

The optical filter 13 which has the above mentioned characteristics is prepared by a widely known method of laminating optical thin films as illustrated, for example, in the above described Document 3. The method includes laminating optical thin films by repeating vacuum depositions of evaporating particles generated by heating inorganic material such as titanium dioxide and silicon dioxide, and the like, on a quartz or glass substrate. Here, by adjusting a refractive index, thickness, or number of laminations of the optical thin films, the optical filter 13 which has the desired characteristics may be obtained.

The optical filter 13 is always inserted into the optical path from the lens unit 12 to the imaging element 14, and therefore, insertion and extraction operations of the optical filter 13 to and from the optical path are not made.

The imaging element 14 is a solid-state imaging element including, for example, a Charge Coupled Device (CCD) type, a Complementary Metal Oxide Semiconductor (CMOS) type, and the like, which converts the incident light passing through the optical filter 13 and falling on a light receiving surface into an electric signal, and outputs the electric signal. The imaging element 14 has sensitivity to the visible region and the infrared region.

The A/D converter 15 converts the electric signal which is an analog signal output from the imaging element 14 into a digital image signal.

The pixel interpolator 16 outputs signals (color signals) of an R component (red-color component), a G component (green-color component), and a B component (blue-color component) for each pixel which constitutes the image by performing pixel interpolation processing to the image signal output from the A/D converter 15.

In the following explanation, the constitution in which the imaging element 14, the A/D converter 15, and the pixel interpolator 16 are combined is called an “imaging element unit”.

The WB controller 17 controls a white balance by performing gain control to the color signals of each component of the three colors output from the pixel interpolator 16.

The color corrector 18 corrects the color signals output from the WB controller 17 and suppresses color deterioration caused by mixture of the infrared light, by approximating spectral sensitivity characteristics of each color of the imaging element unit in the above mentioned specific wavelength band to human cone characteristics. In the present embodiment, the color corrector 18 performs the correction by performing a matrix operation of three type color signals output from the imaging element unit and predetermined correction coefficients. More specifically, the color corrector 18 performs the matrix operation represented by formula (1) as follows.

$$( \begin{matrix}Rout \\ Gout \\ Bout\end{matrix} ) = ( \begin{matrix}α r & α g & α b \\ β r & β g & β b \\ γ r & γ g & γ b\end{matrix} ) ( \begin{matrix}Rin \\ Gin \\ Bin\end{matrix} ) \qquad Formula ( 1 )$$

In formula (1), Rin, Gin, and Bin are the values of the color signals of each component of RGB input into the color corrector 18 from the WB controller 17, while Rout, Gout, and Bout are the values of the color signals of each component of RGB after correction output from the color corrector 18. Further, αr, αg, αb, βr, βg, βb, γr, γg, and γb are correction coefficients.

Explanation is given for derivation of the correction coefficients. The correction coefficients are derived in the developing process or manufacturing process of the imaging apparatus 1.

First, for each of a plurality of samples, values of each component of RGB before correction and target values of each component of RGB after correction are acquired. In the present embodiment, a 24-color sample in the above mentioned Macbeth ColorChecker is used as a color sample. Here, the values of each component of RGB before correction are obtained by imaging each color sample by using the imaging element which has similar characteristics to those of the imaging element 14 of the imaging apparatus 1, and further, by using the optical filter 13 which has the above mentioned characteristics and is used for the imaging apparatus 1. The target values of each component of RGB after correction are obtained by imaging each color sample by using the same imaging element, and further, by using the infrared cut filter which transmits the visible light but blocks the infrared light over its entire wavelength band.

Subsequently, the correction coefficients are obtained by substituting the values of each component of RGB before correction and the target values of each component of RGB after correction acquired for each of the plurality of the color samples in formula (2) below.

$$( \begin{matrix}Rout\_ 1 & Rout\_ 2 & … & Rout\_ 24 \\ Gout\_ 1 & Gout\_ 2 & … & Gout\_ 24 \\ Bout\_ 1 & Bout\_ 2 & … & Bout\_ 24\end{matrix} ) = ( \begin{matrix}α r & α g & α b \\ β r & β g & β b \\ γ r & γ g & γ b\end{matrix} ) ( \begin{matrix}Rin\_ 1 & Rin\_ 2 & … & Rin\_ 24 \\ Gin\_ 1 & Gin\_ 2 & … & Gin\_ 24 \\ Bin\_ 1 & Bin\_ 2 & … & Bin\_ 24\end{matrix} ) \qquad Formula ( 2 )$$

In formula (2), Rin_{—}1, Rin_{—}2, . . . , and Rin_{—}24 are R component values before correction of each 24-color sample. Gin_{—}1, Gin_{—}2, . . . , and Gin_{—}24 are G component values before correction of each 24-color sample. Bin_{—}1, Bin_{—}2, . . . , and Bin_{—}24 are B component values before correction of each 24-color sample. On the other hand, Rout 1, Rout_{—}2, . . . , and Rout_{—}24 are R component target values after correction of each 24-color sample. Gout_{—}1, Gout_{—}2, . . . , and Gout_{—}24 are G component target values after correction of each 24-color sample. Bout_{—}1, Bout_{—}2, . . . , and Bout 24 are B component target values after correction of each 24-color sample.

By substituting these values in formula (2), an equation which includes each correction coefficient defined as an unknown number for each component of the matrix is obtained. In the present embodiment, a solution of the equation is estimated by a method of least square. With this, the values of each correction coefficient are obtained.

The processing of color correction by the color corrector 18 is performed when the normal, visible imaging is performed, that is, when the infrared light is not emitted by the infrared light source 11. When the imaging of the infrared image is performed by lighting the infrared light source 11, the color corrector 18 does not perform processing of color correction, but outputs the non-processed color signals from the WB controller 17 to the γ corrector 19.

The γ corrector 19 performs γ (gamma) corrections to the color signals output from the color corrector 18.

The image quality adjustor 20 performs adjustment processing of image quality, including, for example, intensity of images, contrasts, and the like, to the color signals output from the γ corrector 19.

The display and storage processor 21 converts the image signals constituted of the color signals output from the image quality adjustor 20 into the signals for image display and outputs the signals to the display 22.

The display 22 is a display device such as an Liquid Crystal Display (LCD), an organic Electroluminescence (EL) display, and the like, and displays the images represented by the signals output from the display and storage processor 21.

In addition, the display and storage processor 21 outputs the image signals constituted of the color signals output from the image quality adjustor 20 as Raw data, or outputs the data by applying compression coding with specific compression techniques such as Joint Photographic Experts Group (JPEG) methods, and the like. The output image data are recorded in the recording medium 23.

The imaging apparatus 1 of FIG. 4 is configured as mentioned above.

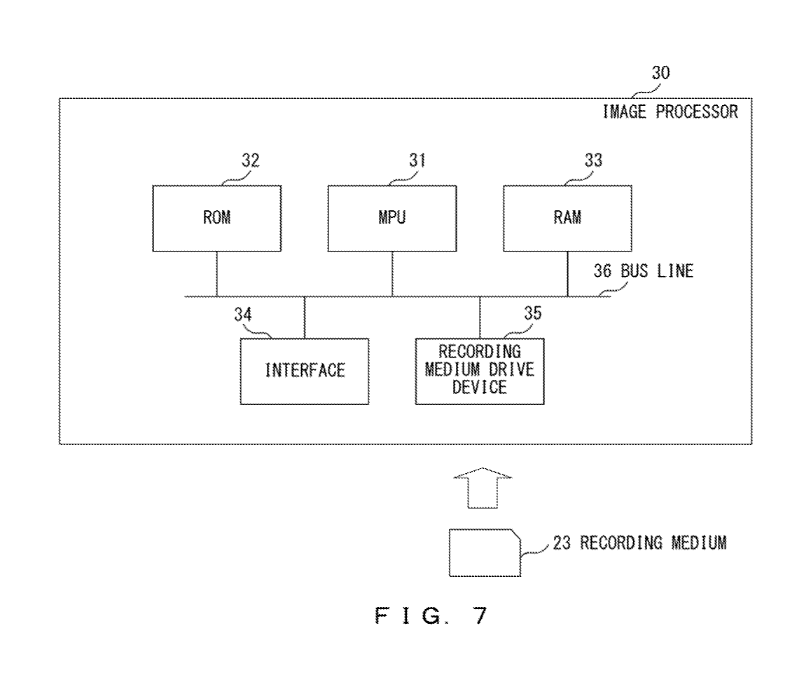

Some of the components in the imaging apparatus 1 may be configured by using the image processor 30, the hardware constitution of which is graphically illustrated in FIG. 7.

The image processor 30 in FIG. 7 includes an Micro Processing Unit (MPU) 31, a Read Only Memory (ROM) 32, a Random Access Memory (RAM) 33, an interface 34, and a recording medium drive device 35. These components are connected via a bus line 36, and may transmit and receive various data with each other under the management of the MPU 31.

The MPU 31 is a processing unit which controls the operation of the entire image processor 30.

The ROM 32 is a read only semiconductor memory in which specific control programs or various constant values are prerecorded. The MPU 31 may control the operation of each component of the image processor 30 and further, may realize the later mentioned control processing, by reading and executing the control program at a start-up of the imaging apparatus 1.

The RAM 33 is a semiconductor memory which is writable and readable at any time and which is used as a storage area for operation, as required, when the MPU 31 executes various control programs.

The interface 34 manages transmission and reception of various data communicated between other components of the imaging apparatus 1, and captures image signals output from the A/D converter 15, and outputs signals for the image display to the display 22, for example.

The recording medium drive device 35 writes or reads data to and from the recording medium 23 and writes the image data which indicates the image imaged by the imaging apparatus 1 to the recording medium 23, for example.

With the above mentioned configuration, the MPU 31 is made to function as the pixel interpolator 16, the WB controller 17, the color corrector 18, the γ corrector 19, the image quality adjustor 20, and the display and storage processor 21. For this, first, a control program for making the MPU 31 perform the image processing performed by each component of the imaging apparatus 1 is prepared. The prepared control program is stored in the ROM 32 in advance. Then, by providing a predetermined instruction to the MPU 31, the MPU 31 is made to read and execute the control program. With this, the MPU 31 starts function as each of the above mentioned components.

In addition, it may be configured that the above mentioned control program is recorded in the recording medium. 23, while a flash memory being used as the ROM 32, and the control program is read from the recording medium 23 with the recording medium drive device 35 to write in the ROM 32. As the recording medium 23, a flash memory, a Compact Disc Read Only Memory (CD-ROM), a Digital Versatile Disc Read Only Memory (DVD-ROM), and the like may be used.

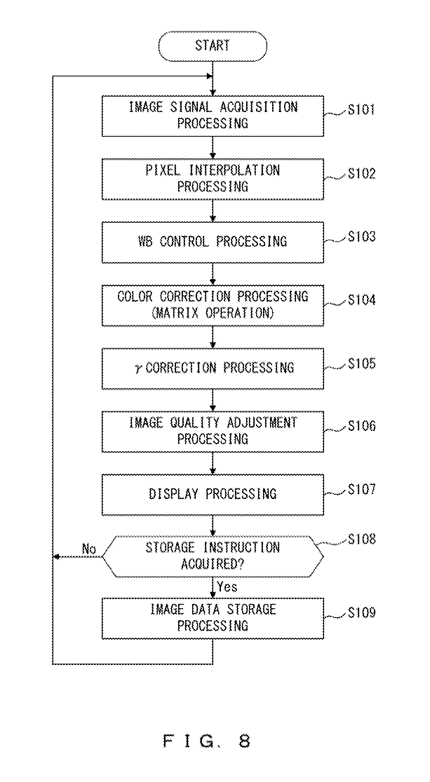

Subsequently, explanation is given for the details of image processing performed by the MPU 31, along the flowchart of FIG. 8.

When the image processing is started, first, in step S101, the MPU 31 performs signal acquisition processing. This processing is the processing of acquiring the image signals output from the A/D converter 15 via the interface 34.

Subsequently, in step S102, the MPU 31 performs pixel interpolation processing. This processing is the processing of acquiring the color signals of each of the RGB components for each pixel constituting the image by performing the pixel interpolation to the image signals acquired by the processing of step S101, and in the constitution of FIG. 4, the processing of step S102 is the processing performed by the pixel interpolator 16.

Subsequently, in step S103, the MPU 31 performs WB control processing. This processing is the processing of controlling a white balance by performing gain control to the color signals of each component of the three colors obtained by the processing of step S102, and in the constitution of FIG. 4, the processing of step S103 is the processing performed by the WB controller 17.

Subsequently, in step S104, the MPU 31 performs color correction processing. This processing is the processing of correcting the color signals after correction by the processing of step S103 and approximating spectral sensitivity characteristics of each color of the imaging element unit in the above mentioned specific wavelength band of the wavelength band of the infrared light transmitted by the optical filter 13 to human cone characteristics. More specifically, in this processing, the above mentioned correction is performed by substituting the color signals of each component of the RGB after the control by the processing of step S103 and each correction coefficient obtained by using the above described formula (2) in the above described formula (1), and by performing the matrix operation. The processing of step S104 is, in the constitution of FIG. 4, the processing performed by the color corrector 18.

Subsequently, in step S105, the MPU 31 performs γ correction processing. This processing is the processing in which the γ correction is performed to the color signals to which the color correction is performed by the processing of step S104, and the processing in step S105 is, in the constitution of FIG. 4, the processing performed by the γ corrector 19.

Subsequently, in step S106, the MPU 31 performs image quality adjustment processing. This processing is the processing in which the adjustment processing of image quality is performed including, for example, intensity of images, contrasts, and the like, to the color signals to which the γ correction is performed by the processing of step S105, and the processing in step S106 is, in the constitution of FIG. 4, the processing performed by the image quality adjustor 20.

Subsequently, in step S107, the MPU 31 performs display processing. This processing is the processing of converting the image signals constituted of the color signals to which the image quality adjustment is performed by the processing of step S106 into the signals for image display, and outputting these signals to the display 22 via the interface 34 to be displayed. The processing in step S107 is, in the constitution of FIG. 4, the processing performed by the display and storage processor 21.

Subsequently, in step S108, the MPU 31 performs processing of judging whether or not the storage instruction of the image is acquired. The storage instruction of the image is provided to the image processor 30 by the user of the imaging apparatus 1 who operates non-illustrated switches included in the imaging apparatus 1. Here, the MPU 31 proceeds the processing to step S109 when judging that it has acquired the storage instruction of the image (when the judgment result is Yes). On the other hand, when judging that the MPU 31 did not acquire the storage instruction of the image (when the judgment result is No), it returns the processing to step S101 and repeats the processing on or after step S101.

In step S109, the MPU 31 performs storage processing. This processing is the processing of making the recording medium 23 record the image data which express the image constituted of the color signals to which the image quality adjustment is performed by the processing of step S106, and the processing in step S109 is, in the constitution of FIG. 4, the processing performed by the display and storage processor 21. The MPU 31 returns the processing to step S101 when it completes the processing of step S109 and repeats the processing on or after step S101.

As the MPU 31 performs the above mentioned image processing, it functions as the pixel interpolator 16, the WB controller 17, the color corrector 18, the γ corrector 19, the image quality adjustor 20, and the display and storage processor 21.

Subsequently, explanation is given for imaging results by the imaging apparatus 1.

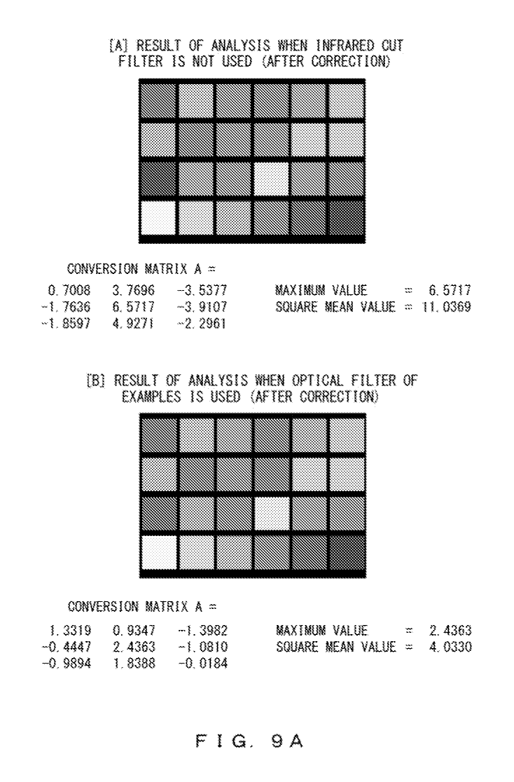

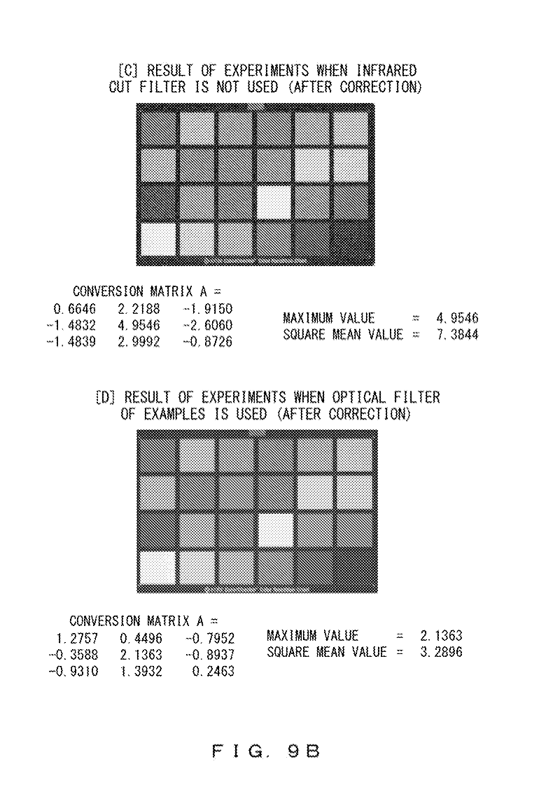

FIGS. 9A and 9B illustrate an image example when color correction by the matrix operation is performed to color signals imaged without using the infrared cut filter, and an image example when the color correction by the matrix operation is performed to the color signals imaged by using the optical filter 13 of the examples.

In FIG. 9A, the image example of [A] is prepared by performing a numerical computation by a computer to the image obtained by performing the color correction by the matrix operation to the color signals imaged without using the infrared cut filter. On the other hand, the image example of [B] is prepared by performing a similar numerical computation by a computer to the image obtained by performing the color correction by the matrix operation to the color signals imaged by using the optical filter 13 which has the characteristics of the embodiment.

Further, in FIG. 9B, the image example of [C] is an actual imaged image of Macbeth ColorChecker obtained by performing the color correction by the matrix operation to the color signals imaged without using the infrared cut filter. On the other hand, the image example of [D] is an actual imaged image of Macbeth ColorChecker obtained by performing the color correction by the matrix operation to the color signals imaged using the optical filter 13 which has the characteristics of the examples.

Under each image of FIGS. 9A and 9B, the values of the correction coefficients used for the matrix operation for the color correction are written down, and further, the maximum value and the square mean value of the coefficients are written down.

When comparing the coefficient values used in the image example of [A] of FIG. 9A with the coefficient values used in the image example of [B] of FIG. 9A, it is seen that the coefficient values are remarkably small when the optical filter 13 which has the characteristics of the examples is used than when the infrared cut filter is not used. This is also seen when comparing the coefficient values used in the image example of [C] of FIG. 9B with the coefficient values used in the image example of [D] of FIG. 9B.

Further, when comparing the image example of [C] with the image example of [D], it is seen that in the image example of [C], roughness by the noise is conspicuously generated in the image of each color sample. Thus, it is seen from the examples of the imaged images as well, that reducing the values of the correction coefficients used for the matrix operation by using the optical filter 13 which has the characteristics of the embodiment brings about beneficial effect in reducing the noise included in the imaged images.

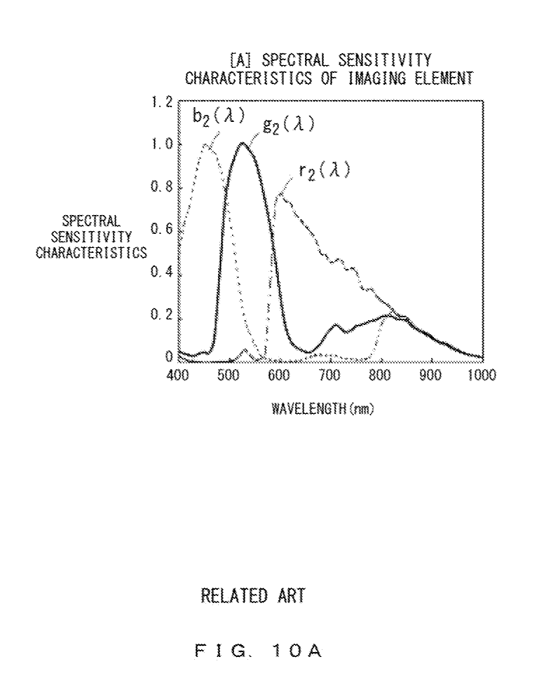

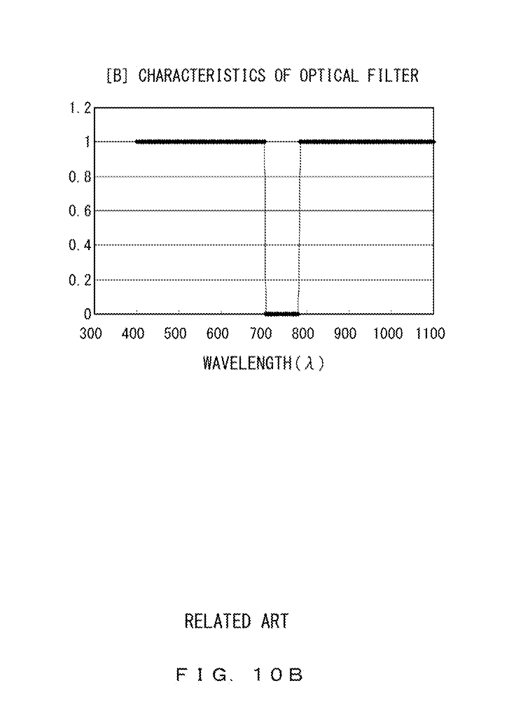

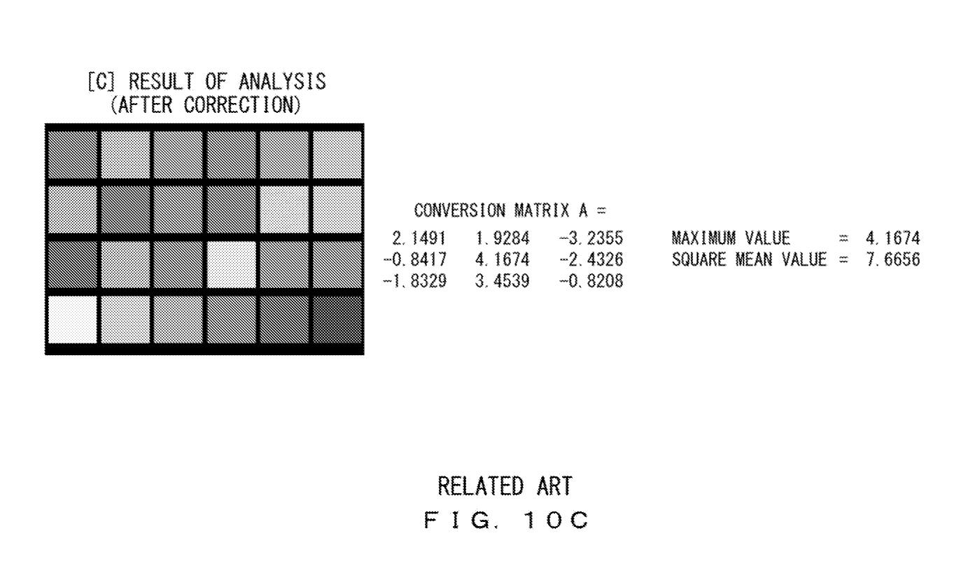

For reference, the correction coefficients are illustrated in FIG. 10C in which the color correction by the matrix operation is performed with the optical filter used in the imaging apparatus described in the above described Document 1.

The graph of [A] in FIG. 10A illustrates the spectral sensitivity characteristics of the imaging element used in the imaging apparatus, and the graph of [B] in FIG. 10B illustrates the characteristics of the optical filter used in the imaging apparatus. In addition, the image example of [C] in FIG. 10C is prepared by performing numerical computation by a computer to the image obtained by performing the color correction by the matrix operation to the color signals imaged by using the optical filter which has the characteristics of [B]. In the right side of the image example of [C], the values of the correction coefficients used in the matrix operation for the color correction are written down, and further, the maximum value and the square mean value of the coefficients are written down.

In the imaging apparatus described in the above described Document 1, in the imaging element which has the characteristics of [A], since the sensitivity of the R signal relative to that of the G signal or B signal is high beyond necessity in the vicinity of 700 to 780 nm, by using the optical filter which has the characteristics of [B], improvement in color reproducibility is intended.

It is seen that the values of the correction coefficients when the optical filter which has the characteristics of [B] is used are remarkably larger than the coefficients used in the image example of [B] of FIG. 9A. Therefore, it is considered that the noise included in the imaged image is reduced when the optical filter 13 which has the characteristics of the embodiment is used than when the optical filter which has the characteristics of [B] of FIG. 10B is used.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An imaging apparatus comprising:
an infrared light source configured to emit an infrared light within a specific wavelength band;
an imaging element configured to output a color signal which corresponds to an incident light;
an optical filter configured to be always inserted into an optical path to the imaging element and attenuate an infrared light with a wavelength outside the specific wavelength band; and
a color corrector configured to correct the color signal output from the imaging element and approximate spectral sensitivity characteristics of each color of the imaging element in the specific wavelength band of a wavelength band of an infrared light to human cone characteristics.

2. The imaging apparatus according to claim 1, wherein:
the imaging element outputs three type color signals which correspond to the incident light; and
the color corrector performs a correction by a matrix operation of the three type color signals output from the imaging element and predetermined correction coefficients.

3. The imaging apparatus according to claim 1, wherein:
the specific wavelength band is in a range of 800 nm to 900 nm.

4. The imaging apparatus according to claim 1, wherein:
a lower limit of the wavelength of the infrared light attenuated by the optical filter is 700 nm.

5. The imaging apparatus according to claim 1, wherein:
the color corrector performs a correction when the infrared light is not emitted by the infrared light source.

6. A method of improving image quality of an image imaged by using an imaging apparatus which includes an infrared light source to emit an infrared light within a specific wavelength band, and an imaging element to output a color signal corresponding to an incident light, the method comprising:
attenuating an infrared light with a wavelength outside the specific wavelength band in the incident light to the imaging element, by inserting an optical filter in an optical path to the imaging element; and
correcting the color signal output from the imaging element and corresponding to the incident light having passed through the optical filter, and approximating spectral sensitivity characteristics of each color of the imaging element in the specific wavelength band of a wavelength band of an infrared light to human cone characteristics.

7. A computer-readable recording medium having stored therein a program for causing a computer to execute a process for improving image quality of an image imaged by using an imaging apparatus which includes an infrared light source to emit an infrared light within a specific wavelength band, and an imaging element to output a color signal corresponding to an incident light, wherein
the imaging apparatus comprises an optical filter configured to be always inserted into an optical path to the imaging element and attenuate an infrared light with a wavelength outside the specific wavelength band, and
the process comprises:
correcting the color signal output from the imaging element and corresponding to the incident light having passed through the optical filter, and approximating spectral sensitivity characteristics of each color of the imaging element in the specific wavelength band of a wavelength band of an infrared light to human cone characteristics; and
causing a display to display an image constituted of the color signal after a correction.
